(19) United States
(12) Patent Application Publication
(10) Pub. No.: US 2005/0279711 A1
(43) Pub. Date: Dec. 22, 2005

(54) Methods and systems for dewatering and gasification

(76) Inventors: Keith Alan Goettert, Los Angeles, CA (US); Richard Kleinke, Commerce City, CO (US); Paul J. Finestone, Studio City, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/963,408

(22) Filed: Oct. 12, 2004

Related U.S. Application Data
(60) Provisional application No. 60/510,431, filed on Oct. 10, 2003.

(51) Int. Cl. C02F 1/24; C02F 11/12; C02F 11/14; C02F 9/02; C02F 9/12; C02F 9/14; B01D 61/58

(52) U.S. Cl. 210/703; 210/652; 210/806; 210/180; 210/769; 210/748; 210/221.2; 210/202; 210/181; 210/184; 210/241

(57) ABSTRACT

Methods and systems for processing animal waste are disclosed. Effluent, including waste solids and water, is received. The effluent is at least partly separated into solids and water. The separated water is processed using a dissolved air flotation device and/or a reverse osmosis system to clarify the separated water. The separated solids are transferred to a gasifier, which processed the separated solids to form a least a first gas.

### PRIORITY APPLICATION

This application claims the benefit of U.S. Provisional Patent Application 60/510,431, filed Oct. 10, 2003, the entire disclosure of which is hereby incorporated by reference herein.

### BACKGROUND OF THE INVENTION

1. Field of the Invention

The present invention is related to waste processing, and in particular, to methods and systems for dewatering waste, sludge and manure for gasification.

2. Description of the Related Art

The efficient and environmentally safe processing of waste, such as animal manure, poses a significant challenge. For example, water may be used to flush such wastes from livestock barns or holding areas, forming a manure “slurry” that can pose a health hazard.

Efforts have been made to remove water from manure waste. However, many conventional processes are prohibitively expensive, and do not efficiently perform dewatering, gasification, and water cleanup. Further, many conventional processes cannot meet certain emerging environmental standards. Using many conventional processes, the amounts of water flow are relatively low and they do not adequately recapture the energy trapped in the solid waste materials.

In particular, certain conventional processes attempt to clean or sterilize the waste water stream without regard to using the solids and thus better clean the environment. For example, one conventional process involves placing the waste solids in large lagoons. However, there are negative environmental consequences to the use of such lagoons, and hence, there have been mandates in some areas to eliminate such lagoons. Additionally, many conventional processes fail to sufficiently clean the water removed from the waste so that the water can be reused in certain process systems.

Certain other conventional systems provide a limited amount of filtering and dewatering. However, such filtering and dewatering often does not remove enough water from the waste solids to make the gasification of the waste solids a practical possibility. As a result, a degree of concentration of the solids occurs, and thus a lagoon waste stream needs to be used, and a small water stream needs cleanup prior to disposal.

Further, many of the aforementioned conventional systems do not provide an adequate integrated solution.

### SUMMARY OF THE INVENTION

The present invention is related to waste, sludge and manure processing, and in particular, to methods and systems for dewatering waste, sludge and/or manure and optionally for providing gasification. For example, one embodiment provides a method for efficiently removing and cleaning water from waste, and for gasifying the separated solid waste materials for other forms of energy generation.

One example embodiment includes dewatering equipment and clarification equipment. Dewatering, water cleanup, and bacteria and pathogens destruction processes are performed. In addition, gasification equipment is utilized to perform gasification of the solid materials. Power generation and gas production systems are optionally incorporated to receive the gas output of the gasification equipment and to generate electricity, steam, or other energy output. The foregoing equipment is optionally packaged as a single unit for transport, setup and operation at a processor site.

One embodiment provides a method removing a large portion of the carrier water from the solids.

Another embodiment provides a method where the water removed is cleaned of very small particulate, bacteria, and pathogens.

Another embodiment collects and gasifies the solids. This gasification process converts the solids to a synthesis gas and a benign ash.

### BRIEF DESCRIPTION OF THE DRAWINGS

To the accomplishment of the above and related objects, the invention may be embodied in the form illustrated in the accompanying drawing, attention being called to the fact, however, that the drawing is illustrative only, and that changes may be made in the specific construction illustrated.

FIG. 1 illustrates an example apparatus and process in accordance with one embodiment of the present invention.

### DETAILED DESCRIPTION OF PREFERRED EMBODIMENTS

The present invention is related to waste processing, and in particular, to methods and systems for dewatering waste and/or for the gasification of solid waste. For example, one embodiment provide a method of efficiently removing and cleaning water from waste, and of gasifying solid waste materials for other forms of energy generation.

By way of illustration, effluent, sludge, or other waste, such as pig manure, chicken manure, bovine manure, sheep manure, human manure, or other manure and urine, may be heavily laden with water. This can occur, for example, when water is used to wash or flush such animal waste from barns, holding areas, manure pits, or other washing stations.

By way of example, the effluent (such as a manure slurry) or other waste/water is transferred by pipe, canal, or using other structures to a dewatering system. In one embodiment, the effluent or other waste laden with water is heated, and then heated air is blown over the heated effluent. The effluent is then filtered. For example, the effluent can be pressed against a fabric or otherwise filtered to thereby press water out of the effluent, through the filter and into a trough or other receptacle.

The solid waste remaining on the fabric or other filter material can be scrapped off, blown off, vibrated off and/or otherwise removed and deposited in a receptacle, on a conveyor, an augur, an elevator and/or the like.

The removed solid waste can then be transferred to a gasifier which produces a gas, such as a combustible gas, that can be used for electrical or other energy generation. The gasification process can include heating the solid waste, which optionally can further destroy bio-active compounds such as antibiotics, virus, pyrogens, and/or prions (which are responsible for transmissible spongiform encephalopathies, including “mad cow” disease or Chronic Wasting Disease). The gasification process converts a large portion of the solid waste, such as the carbonaceous content, into a gaseous fuel, optionally without leaving any, or more than an acceptable amount of solid carbonaceous residue.

The water removed from the effluent during the filtering process can be cleaned, purified, and/or sterilized using one or more processes, examples of which are described herein. For example, dissolved air flotation, reverse osmosis, ultraviolet light, and/or heat can be used to clean or purify the water. The dissolved air flotation process can be applied for the clarification of the waste, and for additional recovery of suspended waste material, thereby further enabling reclaiming the waste water for reuse. The reverse osmosis process uses, for example, one or more membranes to remove dissolved solids, organics, pyrogens, bacteria, as well as other bio-active elements from water. Reverse osmosis can also remove sodium, chloride, hardness, fertilizers, insecticides, arsenic, heavy metals and many other contaminants. Exposure of the water to ultraviolet light acts as a germicidal treatment. With proper exposure, ultraviolet radiation energy/light can penetrate a microorganism's cell wall, destroying the cell's nuclear material. After one or more of the foregoing processes, the water can then be used for facility or other processes.

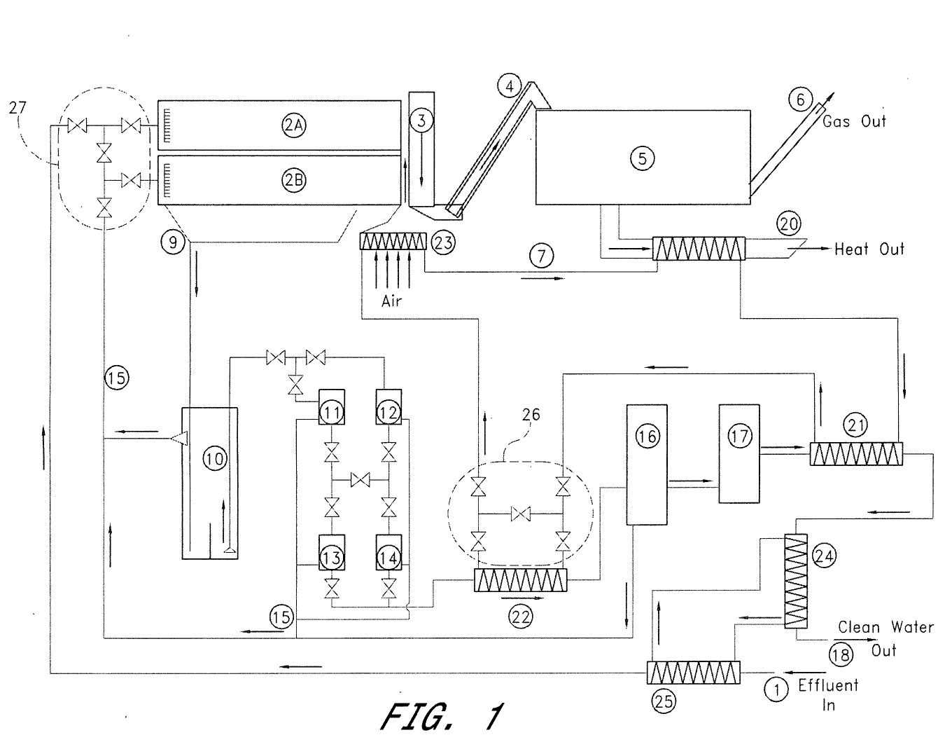

An example embodiment will now be described with reference to FIG. 1. FIG. 1 presents an example waste processing and conversion system (also referred to as a dewatering and gasification system) diagram that illustrates the flow of materials through the system and further illustrates example processes that are performed. However, not all of the following processes need to be performed, nor do they all need to be performed in the order described below or illustrated.

The waste processing and conversion system can optionally include temperature sensors, pressure sensors, valve sensors, chemical sensors, and or the like to monitor waste material temperature, water temperature and/or air temperature, the pressure exerted on effluent or waste material, and the concentrations of waste particles, debris, or other undesirable elements in the water. The monitoring and control of the waste processing and conversion system can be fully or partially automated by including computer monitoring for control and data logging, thereby enabling the optimization and real time control of the process. The waste processing and conversion system is optionally remotely monitored and controlled by a computer control and monitoring system coupled to the waste processing and conversion system via the Internet and/or other networks.

As will now be described in greater detail, the example waste processing and conversion system illustrated in FIG. 1 performs waste dewatering and/or gasification. The equipment illustrated in FIG. 1 is optionally packaged as a single unit for transport, setup and/or operation at a processor site. In this example, the waste processing and conversion system includes a waste dewatering system, such as a screw system, a belt filter, and/or other press systems, a water clarification system, and a gasification system.

As described in greater detail below, a liquid carrier carries solid waste to a dewatering system, such as a press. The solids removed from the liquid carrier are collected from the dewatering press and transported to a gasification unit. The solids are optionally gasified and are optionally converted to a commercially usable synthesis gas and a benign ash. A portion, such as a large portion, of the water is removed and directed to the clarification system and treated.

For example, the water treatment can include treatment with ultraviolet light and/or heat to thereby purify the water to a desired extent. The treated, cleaned or sterilized water is then returned and can be reused as desired and in accordance with the degree of water purity achieved. Specific federal regulations establish certain limits or degrees of cleanliness for the water returned for use. Local state, city, or other local codes may also specify the degree or limits of cleanliness, wherein the degree or limits will vary with the intended final use. Optionally, the extent of the water purification can be selected based on the federal and/or local codes, and the intended use of the purified water.

With reference to FIG. 1, effluent laden with water (up to or greater than 50%-98% water by volume is pumped by a pump from the facility wash stations or holding areas (not shown) to the waste processing and conversion system via a pipe (1) or other transport apparatus. As previously discussed, the effluent or slurry can include animal manure and urine, such as that from cows, pigs, chickens, sheep or humans, as well as other waste materials. The effluent solids can further include fiber, grit, debris, and the like. In most cases the solids are of very small size, such as down to 2 microns, although the actual solid particle size can be greater or less then 2 microns, such as, without limitation, 1.5 microns, 10 microns, 50 microns with respect to the waste, sludge or manure. However, the solids material may also include cellulose in human waste, bedding and floor material from barns and incidental waste up to ¾ inch size. The fluid carried effluent is generally at ambient temperature but depending on climate, concentration, and waste curing, the fluid carried effluent can vary in temperature from 0-1° C. to 100° C. To raise the temperature and thus aid in the subsequent cleanup process, the effluent is passed through a heat exchanger (25), which preferably is highly efficient. The heat exchange cycle will be explained later.

The heated incoming effluent is piped to an entrance diffuser box located at the start end of a gravity belt filter press system (2A, 2B). While the system illustrated in FIG. 1 includes two filter press units 2A, 2B, more or fewer filter press units or other filter units can be used. The filter press units can include a fabric, such as a flat woven cloth or other material, which runs horizontally between squeezing rollers or other pressure devices. In addition or alternatively, one or more screw presses can be used, wherein a screw press includes a screw which forces the effluent through a pipe or tube and through a cylindrical screen to form a plug of manure.

In the illustrated embodiment, filtration is performed via press 2A until a saturated condition is approached or reached. At that point the electrically controlled valves 27 will divert the flow to press 2B while press 2A is cleaned, such as by using hot air blown from the backside of the filter fabric.

Preferably, the filter fabric has a relatively fine mesh which will vary in micron measurement depending on the nature of the feedstock to be dealt with. The finest possible available filtration measurements suitable for such filtering, for example, may optionally be used for pig manure which is notoriously fine. The effluent is distributed on the filter fabric, which can be slow moving. A large portion of the water (such as approximately 45%, although higher or lower percentages can be filtered) is filtered and via gravity, falls to a collection trough (9) or other collection apparatus below the filter fabric. The belt filter material continues to move and is subjected to a pressing action as the filter fabric moves between a series of press rollers (not shown). As it passes through the rollers, additional water is squeezed through the filter fabric and collected in the trough (9) or other collection apparatus. The solid materials remaining on the filter fabric reach the end of the gravity belt filter press and are removed, such as by being scraped off the fabric, and fall into a collection conveyor (3), although other transport apparatus can be used. Air is drawn through a heat exchanger (23) and is blown through the filter fabric from the backside to assist in removing the waste solids from the belt. The removed solids are deposited onto the collection conveyor (3).

The collection conveyor (3) is optionally a moving conveyor with a moving belt made of a fine filter fabric which can act simultaneously as a transport and, by addition of a spill catch, provide secondary filtration. The collection conveyor (3) moves the solid waste materials to the end of the belt, and the solid waste material is collected in a vertical auger assembly (4) or other transport apparatus. The vertical auger (4) physically moves the collected waste material to an elevation suitable for dumping or depositing the waste material it into a gasifier (5).

The gasifier (5) processes carbonaceous materials and produces a synthesis gas which is output by a pipe or hose (6). The gas can then be used for electrical generation, or other form of energy conversion. For example, the gasification process can include one or more of drying, heating, pyrolysing, partial oxidation and reduction. The gasifier can include, by way of example, one or more fixed or solid bed reactors, crossdraft reactors, and/or fluidized-bed reactors that produce a mixture of carbon monoxide and hydrogen, which can then be burned or combusted either alone or combined with gas from other sources. Other types of gasifiers, or modifications of the foregoing gasifiers, can be used as well. For example, a circulating fluid bubbling bed gasification unit, such as that described in European Patent Application publication EP1182248A1, can optionally be used. For example, air can be injected upward through a distributor at the bottom of the bed. The operating temperatures can be in the range of 600-950° C., 700-800° C., or 720-770° C. The materials are distributed across the bed, releasing volatiles, and possibly causing fragmentation. Solid particles rise upwards and enter a cyclone or rotating particle separator. Separated particles are recirculated to the bubbling bed via return conduits.

Another example gasification system that can optionally be utilized is described in PCT Application publication WO 03/004404A2, the contents of which are incorporated herein by reference, which describes a method and apparatus for producing synthesis gas from biomass or other carbonaceous material. A controlled devolatilization reaction is performed in which the temperature of the feed material is maintained at a certain temperature, such as less then 450° F. about (232° C.), until most available oxygen is consumed, to thereby reduce pyrolysis of the feed material. The devolatilization process can be performed utilizing one or more series reaction chambers. A feeder, such as a cyclone feeder, combines the product from the devolatilization process with steam, which may be superheated to a temperature of about 1500° (approximately 816° C.). The result is directed to reaction coils, wherein the heat in the reaction coils is between 1300-1800° F. (approximately 704-982° C.). The carbonaceous product from the devolatilization process reacts with the steam to form carbon monoxide and hydrogen. Ash can be removed using a cyclone separator. The described method and apparatus utilizes the formed synthesis gas to provide the energy for the necessary gasification to provide for a high purity synthetic gas to avoid slag production.

Thus, in one embodiment, a steam reforming gasification process is utilized, which is a form of thermal decomposition in an environment with limited or no oxygen. This limited or no oxygen advantage over conventional fluid bed gasification systems can be expected to yield superior BTU values. In particular, a circulating fluid bed gasification system can be used, with a full or partial “bubbling bed”. The processed waste material, such as manure or sludge, preferably has a dry solid content of at least 70%, preferably at least 80%, still more preferably 85%, although higher or lower percentages of dry solid content can be utilized.

Conventional forms of manure drying may require batch handling and control. There can also be significant handling issues and problems with the rotating particle separators sometimes used on some small scale fluid bubbling bed gasifiers. By contrast, an embodiment of the gasification described herein utilizes a staged gasification, pyrolysis to steam reforming gasification system. One embodiment of the staged gasification system (5) allows wet feedstock of up to 55% moisture content in continuous flow but preferably not more than 50% moisture content in continuous flow to be processed in a continuous flow manner from a waste elimination efficiency viewpoint. No batch drying of feedstock to a condition of 85% dry, no particle beds and no particle recovery and handling systems are required, hence reducing equipment maintenance. From an electrical efficiency viewpoint, moisture content in the continuous flow should preferably not exceed 50% and more preferably not exceed 40%.

The resultant effluent is heated to a temperature at or approaching approximately 1300-1800° F. (approximately 704-982° C.) at which point the organic material decomposes into gasses such as H, CO, CO₂, methane and ash containing minerals. An added benefit is that the high heat destroys bio-active compounds such as antibiotics, virus, and prions. Optionally, one or more of the gasses can have tar removed using, by way of example, a “tar cracker”, a quench system, a wet scrubber system, and/or other tar removal system. For example, the tar cracker can be a thermocatalytical tar cracker, wherein tars are catalytically cracked using a catalyst, such as an Ni catalyst, at a suitable temperature, such as at about 900° C. The gas is thereby converted into smaller combustible gas components. In addition to converting tar, the thermocatalytical tar cracker optionally converts ammonia (NH₃), such as is commonly released when gasifying chicken manure. After the cracking is performed, the gas is optionally cooled via a heat exchanger, such as within a range of approximately 30-80° C., such as just above the gas dew point.

In one embodiment, the gasifier (5) is preferably operated at 35% to 50% moisture levels, although higher or lower moisture levels can be used as well. Internal heat circulation is used to allow operation with a higher than normal moisture content. Preferably the water content is lowered to the 40% range to thus increase the efficiency of the process. The gasification process produces a clean high quality exhaust heat, which flows through a gasifier exhaust pipe (7), and a benign ash. The ash has potential value in various commercial applications, such as a phosphate fertilizer or a feed ingredient. Removal and utilization of the heat will be discussed later.

The gas stream can be converted to electrical energy via a generator, used to heat water in boilers, or transformed into stored 920 BTU synthetic producer gas.

The waste water collection and clean up process will now be described in greater detail. The effluent water removed via the presses (2A, 2B) and collected using the trough (9) is pumped by a pump to a Dissolved Air Floatation (DAF) (10) tank. The DAF (10) is a system that mixes air with water under pressure. This results in the air dissolving in the water. When the pressure is released, bubbles form, much like in carbonated drinks. The bubbles rise and lift suspended solids with them. The air/solids mixture floats to the top of the water (in this example, approximately 20% by volume, although other examples may have different ratios). The air/solids mixture is skimmed off or otherwise feed to a pipe (15) or other transport apparatus to be recycled through the one or more presses (2A, 2B). The overflow from the DAF (10) tank removes water from near the bottom of the tank so as the air/solids mixture moves up, the water moves down, increasing the separation efficiency.

The cleaner water is pumped from the bottom of the DAF system (10) and passed through a filter, such as a duplex media filter (11, 12). The media filters (11, 12) capture larger particles that might bypass the DAF. The water from the media filters (11, 12) is fed into a filter, such as a pair of low pressure filters (13 and/or 14).

In the illustrated example, the duplex media filters (11 and 12), and the low pressure filters (13 and 14) are in parallel so that as one filter starts to plug or has a reduced flow, the plugged filter can be cycled and cleaned while the parallel filter continues to operate, and without stopping the process. In this example, the filter sets are back flush type units to allow automatic cleaning and recycling of the particles to the presses (2A, 2B). The back flush material, which can be approximately 5% (although the percentage can be higher or lower) is recycled via the pipe (15) to the presses (2A, 2B). The resulting flow from the filters (11, 12, 13, 14, collectively referred to as the ultra filter system) is particulate or substantially free. Other embodiments can use more of fewer filters.

In an example embodiment, the product water from the ultra filter system (11, 12, 13, 14) is about 110% of the desired flow rate, although in other embodiments the flow can be higher or lower. The filtered water is fed to a reverse osmosis system (16). By way of example, the reverse osmosis system will remove up to about 99.5% of any remaining dissolved solids, although other embodiments may remove lower or higher percentages of dissolved solids. Reverse osmosis (RO) is a water treatment process that removes undesirable materials from water by using pressure to force the water molecules through a membrane, such as a semi-permeable membrane. This process is called “reverse” osmosis because a concentrated water solution (raw) is forced under pressure through a membrane to yield a diluted water solution (treated), which can be used for consumption. This treated water preferably does not contain significant or unacceptable amounts of contaminants such as; chemicals, ionized salts, heavy metals, collides and/or organic molecules. The reverse osmosis process optionally reduces the molecules down to a molecular weight of about 100 and the rejection of dissolved salts is typically 95% to greater than 99%.

The illustrated example reverse osmosis system (16) has a recycle loop that returns rejected (raw) water to the presses (2A, 2B) via the pipe (15). The recycled flow rate from the reverse osmosis system (16) is about 10% of the total flow rate in one embodiment, although in other embodiments the percentage can be higher or lower. Product water (treated) exiting the reverse osmosis system (16) will have about 98% (although other percentage can result in other embodiments) of the incoming total dissolved solids (TDS) and no or substantially no suspended solids.

The product water from the reverse osmosis system (16) is optionally passed through ultraviolet light emitted by an ultraviolet light source (17). The ultraviolet light source (17) has an intensity selected to kill the bacteria, fungus, microorganisms, etc. The light cavity is designed to maximize or enhance retention time. Optionally, this is performed by slowing the water flow to a desired rate so that water is exposed for a desired or needed amount of time under the sterilizing UV radiation provided by the ultraviolet source, thereby killing the maximum, necessary, and/or desired number of pathogens, bacteria, and the like.

The heat treatment process will now be described in greater detail. The gasification process described above with reference to the gasifier (5) employs relatively high heat (by way of example, 1800° F., 982° C.) to process the solids. The rejected heat is optionally used to enhance the water purification/separation systems, and to provide still additional sterilization by raising the temperature to or above 212° F. (100° C.).

The gasifier exhaust pipe (7) is optionally fitted with a high efficiency heat exchanger (20) to remove the bulk of the heat from the exhaust stream. The heated fluid is transported to a heat exchanger (21) which raises the product water to a temperature of 180° F. (82° C.) or higher to appropriately sterilize the water.

The heated fluid leaving the heat exchanger (21) is directed to the heat exchanger (22). The heat exchanger (22) raises the temperature of the product water entering the reverse osmosis system (16) to provide for the enhanced or optimum efficiency of the reverse osmosis system (16). Electronically controlled bypass valves (26) maintain a selected, preferred, and/or ideal temperature to the reverse osmosis system (16).

The remaining heat is directed to the heat exchanger (23). Air is drawn across the heat exchanger (23) and the hot air is blown from the backside of the belt press material, as discussed above. This hot air dries the solids and aids in cleaning the filter fabric.

The heat exchangers (24, 25) are designed to remove the heat from the product water and transfer the heat to the incoming effluent. For example, if the incoming effluent is at a temperature under 45° C., the incoming effluent can be heated to within a range of 45-75° C., although other temperature ranges can be used as well, to thereby improve or optimize the separation processes that follow.

The product water is then returned to the using facility via an outflow pipe (18). Optionally, the product water will be approximately 50% by volume of the incoming effluent, although other percentages, such as approximately 45% or greater, can be achieved as well. The product water will be free or substantially free of suspended solids, bacteria, pathogens, and the dissolved solids will be reduced by approximately 98% (although higher or lower percentages can be achieved, such as at least 95%, 97%, or 99%). This water is suitable for reuse in the facility process.

Optionally the entire system illustrated in FIG. 1, or portions thereof, can be packaged and sized to be mounted on a truck, all terrain vehicle, and/or other motorized or towed vehicle. Thus, in addition performing the processes described herein at fixed locations, the system can be used in mobile application by mounting the dewatering and gasification system, or portions thereof to a large robust truck, and bringing the dewatering and gasification system to and from low to medium volume generators of waste, sludge and manure. Examples of this could be medium sized egg farmers, hog farms or cattle lots where it may not be economically feasible to have a dedicated, fixed dewatering and gasification system. This allows the dewatering and gasification system to be used in both mobile and stationary positions for periods of time, as needed to eliminate waste ponds and waste material, manure or sludge accumulations, include those that do not have a viable recycling usage. Secondary water from the system could be used as cleaning or animal feed water or as irrigation on fields. When the clean up is complete, the system could be moved to the next location needing the system.

While the foregoing detailed description discloses several embodiments of the present invention, it should be understood that this disclosure is illustrative only and is not limiting of the present invention. It should be appreciated that the specific configurations and operations disclosed can differ from those described above.

1. A method of processing animal waste, comprising:
receiving effluent, including waste solids and water;
using a press to at least partially separate the effluent into solids and water;
processing the separated water, including:
collecting the separated water;
processing the separated water using a dissolved air flotation device to remove solids from the separated water;
processing the separated water from the dissolved air flotation device using a reverse osmosis system to remove therefrom contaminants to provide purer water;
removing heat from the purer water and providing the purer water for use; and
processing the separated solids, including:
collecting the separated solids;
transferring the separated solids to a gasifier;
heating the separated solids to form at least a first gas via the gasifer.

2. The method as defined in claim 1, wherein the effluent includes manure from at least one of a bovine, a pig, a chicken, a sheep, or a human.

3. The method as defined in claim 1, wherein the press is at least one of a gravity belt filter press or a screw press.

4. The method as defined in claim 1, further comprising filtering the water from the dissolved air flotation device using a duplex media filter.

5. The method as defined in claim 1, further comprising:
filtering the water from the dissolved air flotation device using a filter;
flushing the filter to remove particles; and
providing the removed particles to the press.

6. The method as defined in claim 1, further comprising exposing at least a portion of the separated water using ultraviolet light as a germicide.

7. The method as defined in claim 1, wherein the gasifier heats the substantially separated solids to approximately 982 degrees Centigrade.

8. The method as defined in claim 1, further comprising using heat from the gasifier to raise the temperature of the separated water to be processed by the reverse osmosis system.

9. The method as defined in claim 1, further comprising:
using heat from the gasifier to raise the temperature of air drawn across a heat exchanger; and
using the heated air to remove solids from the press.

10. The method as defined in claim 1, wherein the purer water is at least 45% of the volume of the received effluent.

11. The method as defined in claim 1, wherein dissolved solids in the purer water is reduced at least 97% as compared to that of the effluent.

12. The method as defined in claim 1, further comprising generating electricity using the first gas.

13. The method as defined in claim 1, further comprising removing tar from the first gas using at least one of a tar cracker, a quench system, or a wet scrubber system.

14. The method as defined in claim 1, wherein the gasifier is circulating fluid bed gasifier.

15. The method as defined in claim 1, wherein the gasifier is a fluid bed gasifier.

16. The method as defined in claim 1, wherein the gasifier is a fixed bed gasifier.

17. The method as defined in claim 1, wherein the gasifier can process partially separated solids having up to 55% moisture content.

18. The method as defined in claim 1, wherein the gasifier can process partially separated solids having up to 50% moisture content.

19. The method as defined in claim 1, wherein the gasifier can process partially separated solids having up to 40% moisture content.

20. The method as defined in claim 1, further comprising mounting the gasifer and press onto a mobile vehicle for use at a plurality of locations.

21. A method of processing animal waste, comprising:
receiving effluent, including waste solids and water;
at least partially separating the effluent into solids and water;
processing the separated water using at least one of a dissolved air flotation device or a reverse osmosis system to clarify the separated water; and
processing the separated solids, including:
collecting the separated solids;
transferring the separated solids to a gasifier;
processing the separated solids to form at least a first gas.

22. The method as defined in claim 21, wherein the effluent includes manure from at least one of a bovine, a pig, a chicken, a sheep, or a human.

23. The method as defined in claim 21, wherein the act of at least partially separating the solids and water is performed using at least one of a gravity belt filter press or a screw press.

24. The method as defined in claim 21, further comprising filtering the clarified water using a duplex media filter.

25. The method as defined in claim 21, further comprising:
filtering the clarified water using a filter;
flushing the filter to remove particles; and
providing the removed particles to a gravity belt filter press.

26. The method as defined in claim 21, further comprising exposing at least a portion of the clarified water using ultraviolet light as a germicide.

27. The method as defined in claim 21, wherein the gasifier heats the substantially separated solids to approximately 982 degrees Centigrade.

28. The method as defined in claim 21, further comprising using heat from the gasifier to raise the temperature of the separated water before being processed by the at least one of a dissolved air flotation device or a reverse osmosis system.

29. The method as defined in claim 21, further comprising:
using heat from the gasifier to raise the temperature of air drawn across a heat exchanger; and
using the heater air to remove solids from a press used to separate the effluent into solids and water.

30. The method as defined in claim 21, wherein the clarified water is at least 45% of the volume of the received effluent.

31. The method as defined in claim 21, further comprising using a heat exchanger to remove heat from the clarified water.

32. The method as defined in claim 21, wherein dissolved solids in the clarified water is reduced at least 97% as compared to that of the effluent.

33. The method as defined in claim 21, further comprising generating at least one of steam or electricity using the at least one gas.

34. The method as defined in claim 21, further comprising removing tar from the first gas using at least one of a tar cracker, a quench system, or a wet scrubber system.

35. The method as defined in claim 21, further comprising removing tar from the first gas using at least one of a tar cracker, a quench system, or a wet scrubber system.

36. The method as defined in claim 21, wherein the gasifier is circulating fluid bed gasifier.

37. The method as defined in claim 21, wherein the gasifier is a fluid bed gasifier.

38. The method as defined in claim 21, wherein the gasifier is a fixed bed gasifier.

39. The method as defined in claim 21, wherein the gasifier can process partially separated solids having up to 55% moisture content.

40. The method as defined in claim 21, wherein the gasifier can process partially separated solids having up to 50% moisture content.

41. The method as defined in claim 21, wherein the gasifier can process partially separated solids having up to 40% moisture content.

42. The method as defined in claim 21, further comprising mounting the gasifer and a press, used to separate the effluent into solids and water, onto a mobile vehicle for use at a plurality of locations.

43. A waste effluent dewatering and gasification system, comprising:
a press that at least partially separates effluent into solids and water;
a clarification system, including at least one of a dissolved air flotation device or a reverse osmosis system, that clarifies the separated water; and
a gasifier that processes the separated solids to form a least a first gas.

44. The system as defined in claim 43, wherein the effluent includes manure from at least one of a bovine, a pig, a chicken, a sheep, or a human.

45. The system as defined in claim 43, wherein the press includes at least one of a gravity belt filter press or a screw press.

46. The system as defined in claim 43, further comprising a duplex media filter used to filter the clarified water.

47. The system as defined in claim 43, further comprising an ultraviolet light source used to kill organisms in at least a portion of the clarified water.

48. The system as defined in claim 43, wherein the gasifier is configured to heat the substantially separated solids to approximately 982 degrees Centigrade.

49. The system as defined in claim 43, further comprising a heat exchanger used to transfer heat from a gasifier exhaust to the separated water before being processed by the at least one of the dissolved air flotation device or the reverse osmosis system.

50. The system as defined in claim 43, further comprising a heat exchanger used to transfer heat from the gasifier to raise the temperature of air drawn across the heat exchanger, wherein the heated air to used to remove solids from the press.

51. The system as defined in claim 43, wherein the clarified water is at least 45% of the volume of the received effluent.

52. The system as defined in claim 43, wherein dissolved solids in the clarified water is reduced at least 97% as compared to that of the effluent.

53. The system as defined in claim 43, wherein the system is packaged as a single unit for transportation.

54. The system as defined in claim 43, further comprising at least a tar cracker system used to remove gas tar.

55. The system as defined in claim 43, further comprising at least a quench system used to remove gas tar.

56. The system as defined in claim 43, wherein the gasifier is a circulating fluid bubbling bed gasification unit.

57. The system as defined in claim 43, wherein the gasifier is a circulating fluid bed gasification unit.

58. The system as defined in claim 43, wherein the gasifier is a fixed bed gasification unit.

59. The system as defined in claim 43, further comprising a motor vehicle used to move the system from location to location.
